(19) United States
(12) Patent Application Publication
(10) Pub. No.: US 2015/0116529 A1
(43) Pub. Date: Apr. 30, 2015

(54) AUTOMATIC EFFECT METHOD FOR PHOTOGRAPHY AND ELECTRONIC APPARATUS

(71) Applicant: HTC Corporation, Taoyuan County (TW)

(72) Inventors: Jing-Lung WU, Taoyuan County (TW); Hsin-Ti CHUEH, Taoyuan County (TW); Fu-Chang TSENG, Taoyuan County (TW); Pol-Lin TAI, Taoyuan County (TW); Yu-Cheng HSU, Taoyuan County (TW)

(73) Assignee: HTC Corporation, Taoyuan County (TW)

(21) Appl. No.: 14/272,513

(22) Filed: May 8, 2014

Related U.S. Application Data
(60) Provisional application No. 61/896,136, filed on Oct. 28, 2013.
(60) Provisional application No. 61/923,780, filed on Jan. 6, 2014.

(51) Int. Cl. H04N 5/232

(52) U.S. Cl. CPC H04N 5/23222
USPC 348/222.1

(57) ABSTRACT

An electronic apparatus includes an camera set, an input source module, an auto-engine module and a post usage module. The camera set is configured for capturing image data relative to a scene. The input source module is configured for gathering information related to the image data. The auto-engine module is configured for determining at least one suitable photography effect from a plurality of candidate photography effects according to the information related to the image data. The post usage module is configured for processing the image data and applying the suitable photography effect to the image data after the image data are captured.

### CROSS-REFERENCE TO RELATED APPLICATION

This application claims the priority benefit of U.S. Provisional Application Ser. No. 61/896,136, filed Oct. 28, 2013, and No. 61/923,780, filed Jan. 6, 2014, the full disclosures of which are incorporated herein by reference

### FIELD OF INVENTION

The invention relates to a photography method/device. More particularly, the invention relates to a method of determining a suitable photograph effect and a device thereof.

### BACKGROUND

Photography used to be a professional job, because it requires much knowledge in order to determine suitable configurations (e.g., controlling an exposure time, a white balance, a focal distance) for shooting a photo properly. As complexity of manual configurations of photography has increased, required operations and background knowledge of user have increased.

Most digital cameras (or a mobile device with a camera module) have a variety of photography modes, e.g., smart capture, portrait, sport, dynamic, landscape, close-up, sunset, backlight, children, bright, self-portrait, night portrait, night landscape, high-ISO and panorama, which can be selected by the user, in order to set up the digital cameras into a proper status in advance before capturing photos.

On a digital camera, the photography mode can be selected from an operational menu displayed on the digital camera or by manipulating function keys implemented on the digital camera.

### SUMMARY

An aspect of the disclosure is to provide an electronic apparatus. The electronic apparatus includes a camera set, an input source module and an auto-engine module. The camera set is configured for capturing image data. The input source module is configured for gathering information related to the image data. The auto-engine module is configured for determining at least one suitable photography effect from a plurality of candidate photography effects according to the information related to the image data. The information includes a focusing distance of the camera set related to the image data.

Another aspect of the disclosure is to provide a method, suitable for an electronic apparatus with a camera set. The method includes steps of: capturing image data by the camera set; gathering information related to the image data, the information comprising a focusing distance of the camera set related to the image data; and, determining at least one suitable photography effect from a plurality of candidate photography effects according to the information related to the image data.

Another aspect of the disclosure is to provide a non-transitory computer readable storage medium with a computer program to execute an automatic effect method. The automatic effect method includes steps of: in response to image data are captured, gathering information related to the image data, the information comprising a focusing distance of the camera set related to the image data; and, determining at least one suitable photography effect from a plurality of candidate photography effects according to the information related to the image data.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating an electronic apparatus according to an embodiment of this disclosure;

FIG. 2 is a flow-chart diagram illustrating an automatic effect method utilized by the electronic apparatus in an illustrational example according to an embodiment;

FIG. 3 is a flow-chart diagram illustrating an automatic effect method utilized by the electronic apparatus in another illustrational example according to an embodiment;

FIG. 4A, FIG. 4B, FIG. 4C and FIG. 4D are examples of depth histograms corresponding to different depth distributions.

FIG. 5 is a method for providing a user interface according to an embodiment of the disclosure.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

An embodiment of the disclosure is to introduce a method for automatically determining corresponding photography effects (e.g., an optical-like effect to change aperture, focus and depth of field on the image data by software simulation) based on various information, such as a focusing distance (acquired from a position of a voice coil motor), RGB histograms, a depth histogram and an image disparity. As a result, a user can generally capture photos without manually applying the effects, and appropriate photography effects/configurations can be detected automatically and can be applied during post-usage (e.g., when user reviews the photos) in some embodiments. The details of operations are disclosed in following paragraphs.

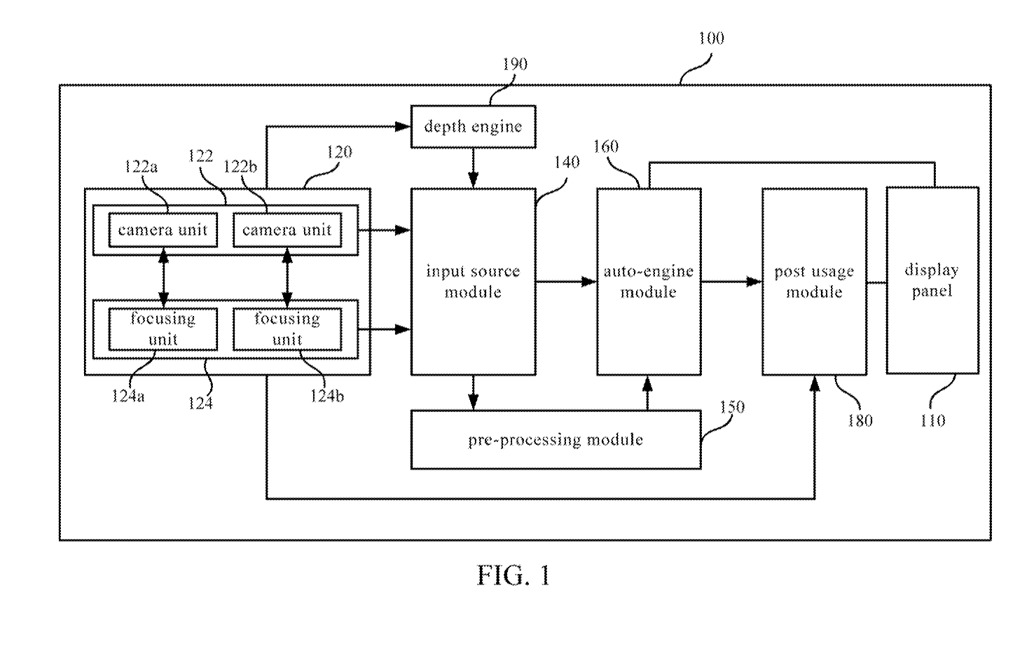

Reference is made to FIG. 1, which is a schematic diagram illustrating an electronic apparatus 100 according to an embodiment of this disclosure. The electronic apparatus 100 includes a camera set 120, an input source module 140 and an auto-engine module 160. In the embodiment show in FIG. 1, the electronic apparatus 100 further includes a post usage module 180 and a pre-processing module 150. The pre-processing module 150 is coupled with the input source module 140 and the auto-engine module 160.

The camera set 120 includes a camera module 122 and a focusing module 124. The camera module 122 is configured for capturing the image data. In practices, the camera module 122 can be a singular camera unit, a pair of camera units (e.g., an implementation of dual cameras) or plural camera units (an implementation of multiple cameras). As the embodiment shown in FIG. 1, the camera module 122 includes two camera units 122a and 122b. The camera module 122 is configured for capturing image data relative to a scene. The image data can be processed and stored as a photo(s) on the electronic apparatus 100. As the embodiment of present invention, two image data are individually captured by two camera units 122a and 122b and the two image data can be processed and stored as two photos on the electronic apparatus 100.

The focusing module 124 is configured for regulating the focusing distance utilized by the camera module 122. As the embodiment shown in FIG. 1, the focusing module 124 includes a first focusing 124a and a second focusing 124b corresponding to the camera units 122a and 122b respectively. For example, the first focusing 124a regulates a first focusing distance of the camera unit 122a, and the second focusing 124b regulates a second focusing distance of the camera unit 122b.

The focusing distance is a specific distance between a target object of the scene and the camera module 122. In an embodiment, each of the first focusing 124a and the second focusing 124b includes a voice coil motor (VCM) for regulating a focal length of the camera unit 122a/122b in correspondence to the focusing distance. In some embodiments, the focal, length means a distance between lens and a sensing array (e.g., a CCD/CMOS optical sensing array) within the camera unit 122a/122b of the camera module 122.

In some embodiment, the first focusing distance and the second focusing distance are regulated separately, such that the camera units 122a and 122b are capable to focus on different target objects (e.g., a person at the foreground and a building at the background) at the same time within the target scene.

In other embodiments, the first focusing distance and the second focusing distance are synchronized to be the same, such that the two image data outputted from the camera units 122a and 122b can show the same target observed from slight different visional angles, and the image data captured in this case are useful for establishing depth information or simulating 3D effects.

The input source module 140 is configured for gathering information related to the image data. In the embodiment, the information related to the image data includes the focusing distance(s). The input source module 140 acquires the focusing distance(s) from the focusing module 124 (e.g., according to a position of the voice coil motor).

In the embodiment shown in FIG. 1, the electronic apparatus 100 further includes a depth engine 190, which is configured for analyzing a depth distribution of the image data relative to the scene. In exemplary embodiment of the present disclosure, depth information could be obtained by such as, but not limited to, analysis result of images of single camera, dual cameras, multiple cameras or a single camera with distance detecting sensor such as laser sensors, infrared ray (IR) sensors, or light pattern sensors. The depth distribution, for example, can be represented by a depth histogram or depth map. In the depth histogram, pixels within the image data are classified by their depth value, such that various objects (in the scene of the captured image data) located at different distances from the electronic apparatus 100 can be distinguished by the depth histogram. In addition, the depth distribution can be utilized to analyze main subject, edges of objects, spatial relationships between objects, the foreground and the background in the scene.

In some embodiments, the information related to the image data gathered by the input source module 140 further includes the depth distribution from the depth engine 190 and aforesaid relative analysis results (e.g. main subject, edges of objects, spatial relationships between objects, the foreground and the background in the scene) from the depth distribution.

In some embodiments, the information gathered by the input source module 140 further includes sensor information of the camera set 120, image characteristic information of the image data, system information of the electronic apparatus 100 and other related information.

The sensor information includes camera configurations of the camera module 122 (e.g., the camera module 122 is formed by single, dual or multiple camera units), automatic focus (AF) settings, automatic exposure (AE) settings and automatic white-balance (AWB) settings.

The image characteristic information of the image data includes analyzed results from the image data (e.g., scene detection outputs, face number detection outputs, and other detection outputs indicating portrait, group, or people position) and exchangeable image file format (EXIF) data related to the captured image data.

The system information includes a positioning location (e.g., GPS coordinates) and a system time of the electronic apparatus.

Aforesaid other related information can be histograms in Red, Green and Blue colors (RGB histograms), a brightness histogram to indicate the scene for light status (low light, flash light), a backlight module status, an over-exposure notification, a variation of frame intervals and/or a global shifting of the camera module 122. In some embodiments, aforesaid related information can be outputs from an Image Signal Processor (ISP) of the electronic apparatus 100, not shown in FIG. 1.

Aforesaid information related to the image data fine hiding the focusing distance, the depth distribution, the sensor information, the system information and/or other related information) can be gathered by the input source module 140 and stored along with the image data in the electronic apparatus 100.

It is noticed that, the gathered and stored information in the embodiment is not limited to affect the parameters/configurations of the camera set 120 directly. On the other hand, the gathered and stored information can be utilized to determine one or more suitable photography effect, which is appropriate or optimal related to the image data, from plural candidate photography effects by the auto-engine module 160 after the image data is captured.

The auto-engine module 160 is configured for determining and recommending at least one suitable photography effect from the candidate photography effects according to the information gathered by the input source module 140 and related to the image data. In some embodiments, the candidate photography effects includes at least one effect selected from the group including bokeh effect, re focus effect, macro effect, pseudo-3D effect, 3D-alike effect, 3D effect and a flyview animation effect.

The pre-processing module 150 is configured to determine whether the captured image data is valid to apply any of the candidate photography effects or not according to the image characteristic information, before the auto-engine module 160 is activated for determining and recommending the suitable photography effect. When the pre-processing module 150 detects that the captured image data is invalid to apply any candidate photography effect, the auto-engine module 160 is suspended from further computation, so as to prevent the auto-engine module 160 from useless computation.

For example, the pre-processing module 150 in the embodiment determines whether the image data can apply the photography effects according to the EXIF data. In some practical applications, the EXIF data include dual image information corresponding to a pair of photos of the image data (from the dual camera units), time stamps corresponding to the pair of photos, and focusing distances of the pair of photos.

The dual image information indicates whether the pair of photos is captured by the dual camera units (e.g., two camera units in dual-cameras configuration). The dual image information will be valid when the pair of photos is captured by the dual camera units. The dual image information will be void when the pair of photos is captured by a singular camera, or by different cameras which are not configured in the dual-cameras configuration.

In an embodiment, when a time difference between two time stamps of dual photos is too large (ex., larger than 100 ms), the pair of photos is not valid to apply the photography effect designed for dual camera units.

In another embodiment, when there are no valid focusing distances found in the EXIF data, it suggests that the pair of photos fail to focus on specific target, such that the pair of photos is not valid to apply the photography effect designed for dual camera units.

In another embodiment, when there is no valid pair of photos (fail to find any two related photos captured by dual camera units), it suggests that the pre-processing module 150 fails to find any two related photos captured by dual camera units from the EXIF data, such that the image data is not valid to apply the photography effect designed for dual camera units.

The post usage module 180 is configured for processing the image data and applying the suitable photography effect to the image data after the image data are captured. For example, when user reviews images/photos existed in a digital album of the electronic apparatus 100, the auto-engine module 160 can recommend a list of suitable photography effects for each image/photo in the digital album. The suitable photography effects can be displayed, highlighted or enlarged in a user interface (not shown in figures) displayed on the electronic apparatus 100. Or in another case, the photography effects which are not suitable for a specific image/photo can be faded out or hidden from a list of the photography effects. Users can select at least one effect from the recommend list shown in the user interface. Accordingly, the post usage module 180 can apply one of the suitable photography effects to the existed image data and then display in the user interface if user selects any of the recommended effects from the recommended list (including all of the suitable photography effects).

In one embodiment, before any recommended effect is ever selected by user, images/photos shown in the digital album of the electronic, apparatus 100 may automatically apply a default photography effect (e.g., a random effect from the suitable photography effects, or a specific effect from the suitable photography effects). In another embodiment, after one of the recommended effects is selected by user, an effect selected by the user may be applied to the images/photos shown in the digital album automatically. If the user re-selects another effect from the recommended list, a latest effect selected by the user will be applied to the images/photos.

The bokeh effect is to generate a blur area within the original image data so as to simulate that the blur area is out-of-focus while image capturing. The refocus effect is to re-assign a focusing distance or an in-focus subject within the original image data so as to simulate the image data under another focusing distance. For example, the image/photo applied the refocus effect provides capability for user to re-assign the focusing point, e.g., by touching/pointing on touch screen of the electronic apparatus 100, on a specific object of scene. The pseudo-3D or 3D-alike (also known as 2.5D) effect is to generate a series of images (or scenes) to simulate the appearance of being 3D images by 2D graphical projections and similar techniques. The macro effect is to create 3D mesh on a specific object of the original image data in the scene to simulate capturing images through 3D viewing from different angles. The flyview animation effect is to separate an object and a background in the scene and generate a simulation animation, in which the object is observed by different view angles along a moving pattern. Since there are many prior arts discussing how the aforesaid effects are produced, the technical detail of generating the aforesaid effects is skipped in here.

There are some illustrational examples introduced in following paragraphs for demonstrating how the auto-engine module 160 determines and recommends the suitable photography effect from the candidate photography effects.

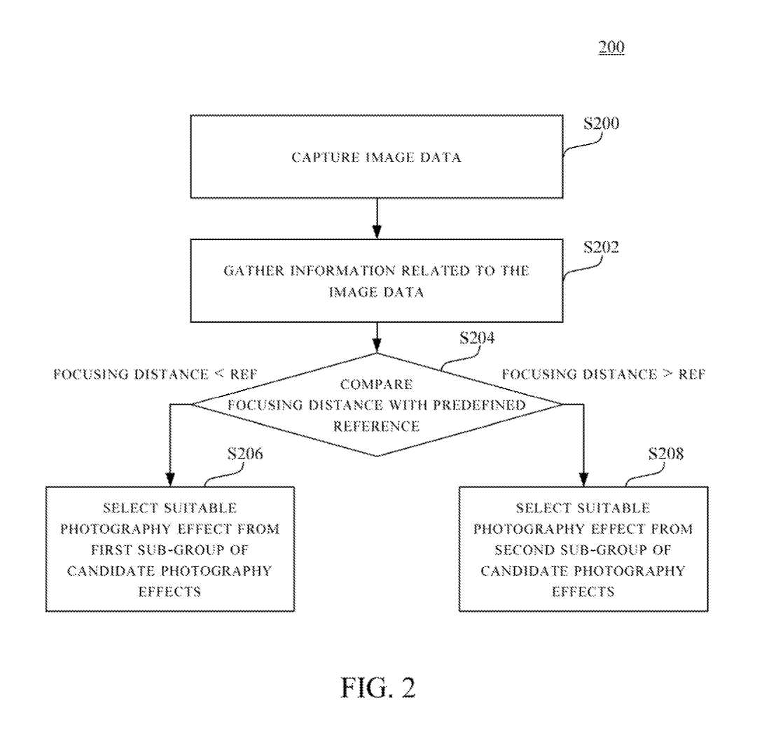

Reference is also made to FIG. 2, which is a flow-chart diagram illustrating an automatic effect method 200 utilized by the electronic apparatus 100 in an illustrational example according to an embodiment.

As shown in FIG. 1 and FIG. 2, operation S200 is executed for capturing image data by the camera set 120. Operation S202 is executed for gathering information related to the image data. In this case, the information includes a focusing distance of the camera set related to the image data. Operation S204 is executed for comparing the focusing distance with a predefined reference.

In this embodiment, some of the candidate photography effects are regarded to be possible candidates when the focusing distance is shorter than the predefined reference. For example, the macro effect, the pseudo-3D effect, the 3D-alike effect, the 3D effect and the flyview animation effect from the candidate photography effects are possible candidates when focusing distance is shorter than the predefined reference, because the subject within the scene will be large and vivid enough for aforesaid effects when the focusing distance is short. In this embodiment, the macro effect, the pseudo-3D effect, the 3D-alike effect, the 3D effect or the flyview animation effect form a first sub-group within all of the candidate photography effects. The operation S206 is executed for selecting a suitable one from the first sub-group of the candidate photography effects as the suitable photography effect.

In this embodiment, some of the candidate photography effects are regarded to be possible candidates when the focusing distance is longer than the predefined reference. For example, the bokeh effect and the refocus effect from the candidate photography effects are possible candidates when focusing distance is longer than the predefined reference, because objects in the foreground and other objects in the background are easy to be separated when the focusing distance is long, such that the image data in this case is good for aforesaid effects. In this embodiment, the bokeh effect and the refocus effect form a second sub-group within all of the candidate photography effects. The operation S208 is executed for selecting a suitable one from the second sub-group of the candidate photography effects as the suitable photography effect.

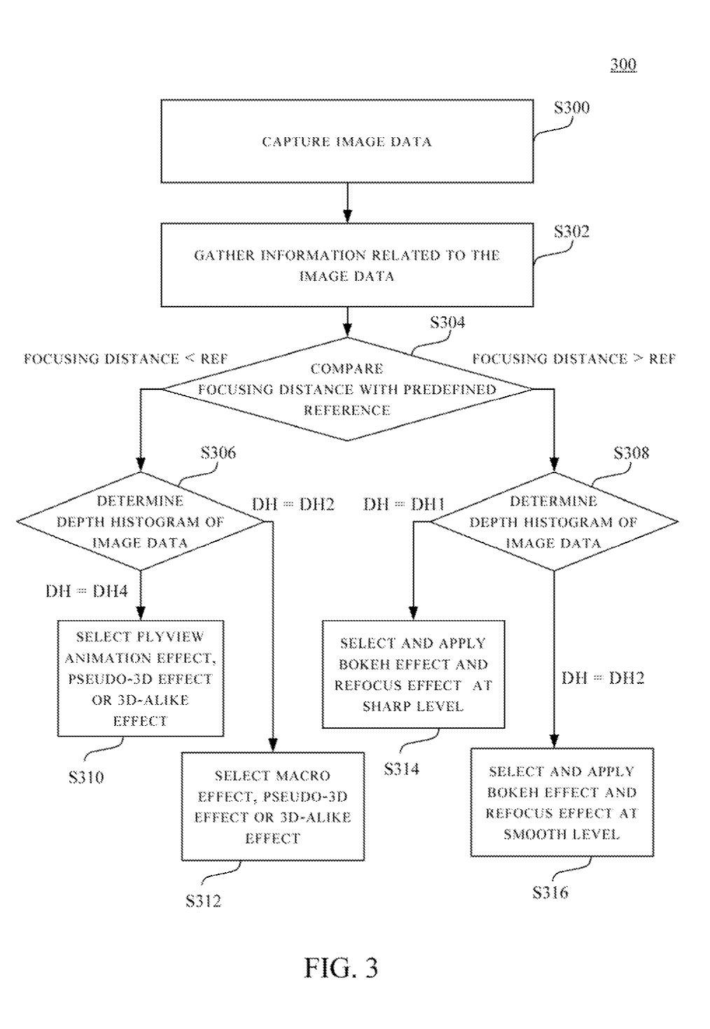

Reference is also made to FIG. 3, which is a flow-chart diagram illustrating an automatic effect method 300 utilized by the electronic apparatus 100 in another illustrational example according to an embodiment. In the embodiment shown in FIG. 3, the auto-engine module 160 determines and recommends the suitable photography effect or a parameter thereof according to the depth distribution in addition to the focusing distance and the information related to the image data. For example, the parameter includes a sharpness level or a contrast strength level (applied, on the bokeh effect and the refocus effect).

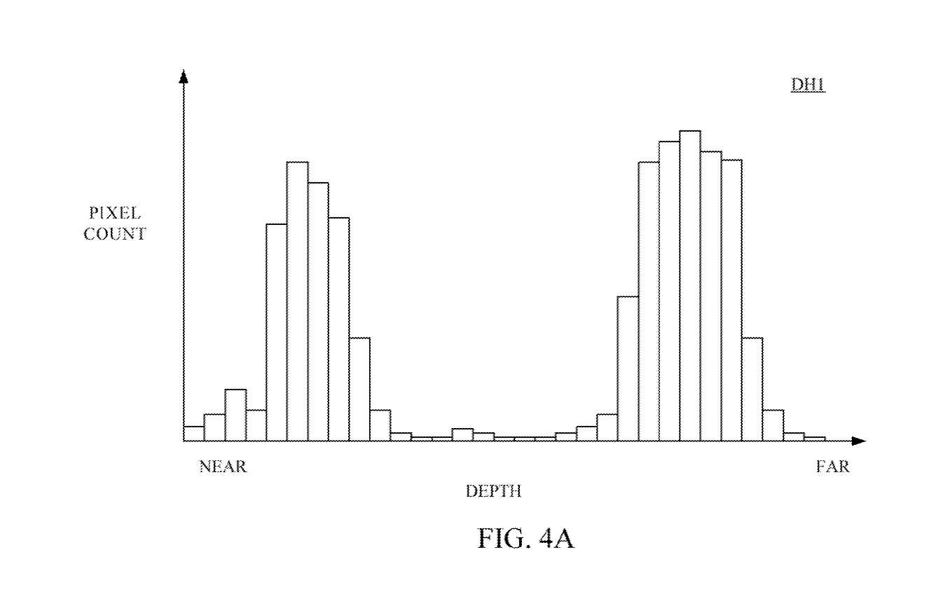

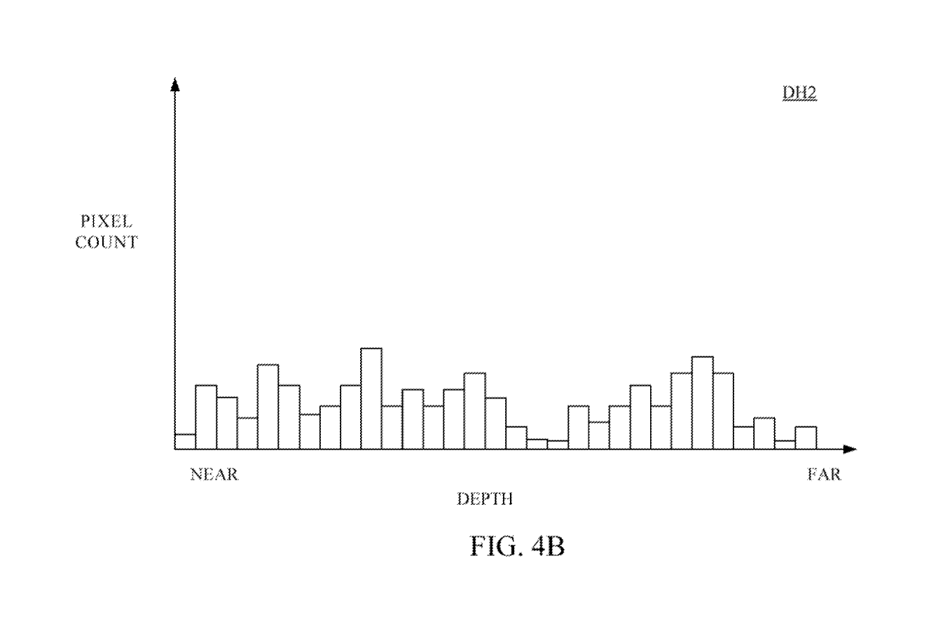

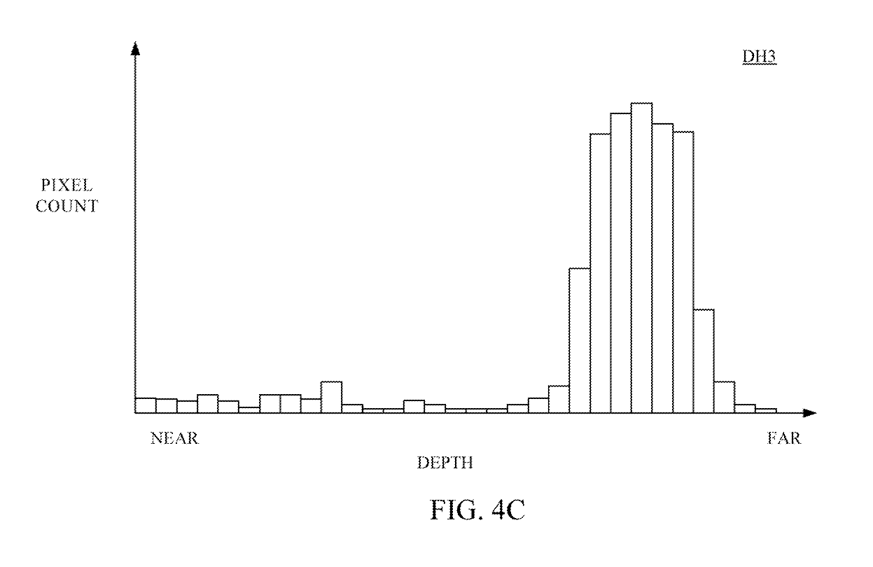

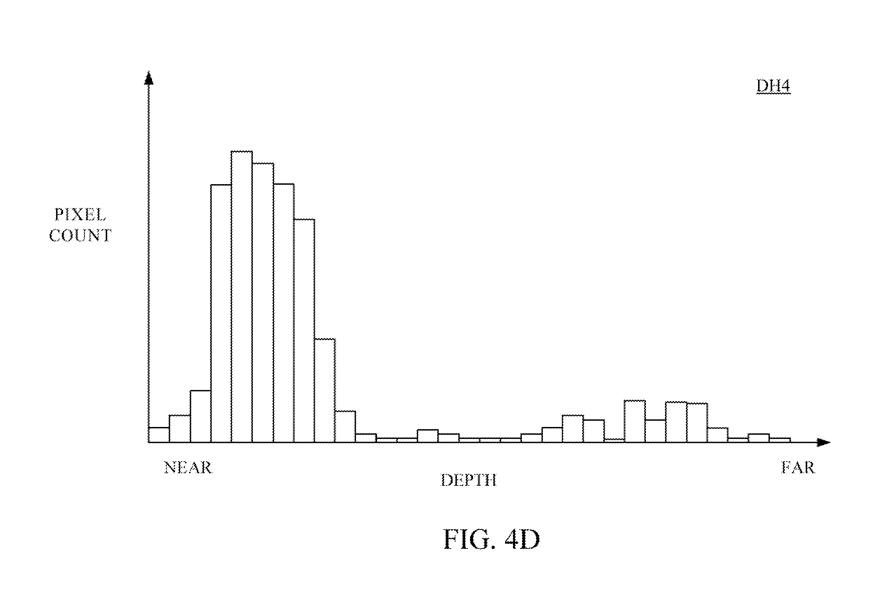

Reference is also made to FIG. 4A, FIG. 4B, FIG. 4C and FIG. 40, which are examples of depth histograms corresponding to different depth distributions. FIG. 4A shows a depth histogram DH1, which indicates that there are at least two main objects in the image data. At least one of them is located at the foreground, and at least the other is located at the background. FIG. 4B shows another depth histogram DH2, which indicates that there are several objects distributed evenly at different, distances from the electronic apparatus 100. FIG. 4C shows another depth histogram DH3, which indicates that there are objects gathered at the far end from the electronic apparatus 100. FIG. 4D shows another depth histogram DH4, which indicates that there are objects gathered at the near end adjacent to the electronic apparatus 100.

In FIG. 3, operation S300, S302 and S304 is same as operation S200, S202 and S204 respectively. When the focusing distance is shorter than the predefined reference, operation S306 is further executed for determining the depth histogram DH of the image data. If the depth histogram DH of the image data is similar to the depth histogram DIM shown in FIG. 4D, operation S310 is executed for selecting the flyview animation effect, the pseudo-3D effect or the 3D-alike effect as the suitable photography effect, because the main object of the image data is obvious in this situation.

When the focusing distance is shorter than the predefined reference and the depth histogram DH of the image data is similar to the depth histogram DH2 shown in FIG. 4B, operation S312 is executed for selecting the macro effect, the pseudo-3D effect or the 3D-alike effect as the suitable photography effect, because there are many objects in the image data.

When the focusing distance is longer than the predefined reference, operation S308 is further executed for determining the depth histogram DH of the image data. If the depth histogram DH of the image data is similar to the depth histogram DH1 shown in FIG. 4A, operation S314 is executed for selecting and applying the bokeh effect and refocus effect at a sharp level, which means the high contrast strength level of bokeh effect, because two main objects are located at the foreground and the background in the image data.

When the focusing distance is longer than the predefined reference and the depth histogram DH of the image data is similar to the depth histogram DH2 shown in FIG. 4B, operation S316 is executed for selecting and applying the bokeh effect and refocus effect at a smooth level, which means the low contrast strength level of bokeh effect, because there are many objects are located at different distances in the image data.

When the focusing distance is longer than the predefined reference and the depth histogram DFS of the image data is similar to the depth histogram DH3 shown in FIG. 4C, the bokeh effect is not suitable here, because objects are all located at the far end in the image data.

It is noticed that illustrational examples shown in and FIG. 2 and FIG. 3 are used for demonstration, and the auto-engine module 160 is not limited to select the suitable photography effect according to FIG. 2 or FIG. 3. The auto-engine module 160 can determine the suitable photography effect according to all information gathered by the input source module 140.

The depth distribution is utilized to know subject locations, distances, ranges, spatial relationships. Based on the depth distribution, the subject of the image data is easy to find out according to the depth boundary. The depth distribution also reveals the contents/compositions of the image data. The focusing distance from the voice coil motor (VCM) and other relation information (e.g. from the image signal processor (ISP)) reveals the environment conditions. The system information reveals the time, location, in/out-door of the image data. For example, system information from a Global Positioning System (GPS) of the electronic apparatus 100 can indicate the image data is taken in-door or out-door, or near a famous location. The GPS coordinates can hint what object of image user would like to emphasize according to the location of images taken such as indoor or outdoor. System information from a gravity-sensor, a gyro-sensor or a motion sensor of the electronic apparatus 100 can indicate a capturing posture, a shooting angle or a stable degree while shooting, which is related to compensation or effect.

In some embodiment, the electronic apparatus 100 further includes a display panel 110 (as shown in FIG. 1). The display panel 110 is configured for displaying photos within the image data and also displaying a selectable user interface for selecting the at least one suitable photography effect related to the photos. In some embodiment, the display panel 110 is coupled with the auto-engine module 160 and the post usage module 180, but this disclosure is not limited to this.

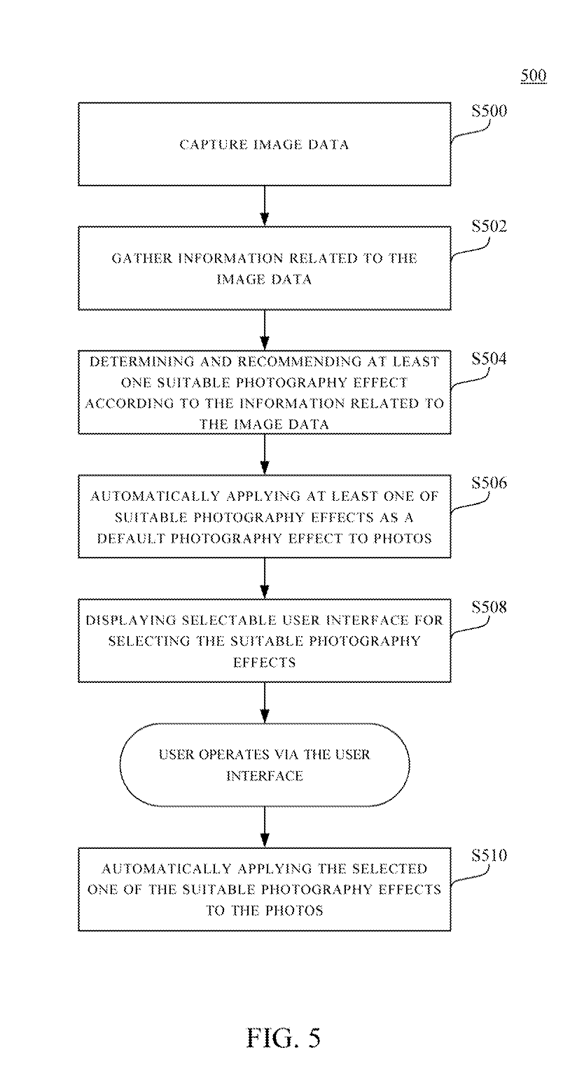

Reference is made to FIG. 5, which is a method 500 for providing a user interface on the display panel 110 according to an embodiment of the disclosure. As shown in FIG. 5, step S500 is executed for capturing image data by the camera set. Step S502 is executed for gathering information related to the image data. Step S504 is executed for determining and recommending at least one suitable photography effect from a plurality of candidate photography effects according to the information related to the image data. Aforesaid steps S500 to S504 are explained in details in aforesaid embodiments and can be referred to steps S200 to S208 in FIG. 2 and steps S300 to S316 in FIG. 3, and not to be repeated here.

In embodiment, the method 500 further executes step S508 for displaying at least one selectable user interface for selecting one from at least one suitable photography effect related to the image data. The selectable user interface shows some icons or functional bottoms corresponding to different photography effects. The icons or functional bottoms of the recommended/suitable photography effects can be highlighted or arranged/ranked at the high priority. The icons or functional bottoms not in the recommended/suitable list can be grayed out, deactivated or hidden.

In addition, before a recommended photography effect (from the suitable photography effects) is selected by the user, the method 500 further executes step S506 for automatically applying at least one of suitable photography effects as a default photography effect to photos shown in a digital album of the electronic apparatus.

Furthermore, after the recommended photography effect (from the suitable photography effects) is selected, the method 500 further executes step S510 for automatically applying the latest selected one of the recommended photography effects to the photos shown in a digital album of the electronic apparatus.

Based on aforesaid embodiments, the disclosure introduces an electronic apparatus and a method for automatically determining corresponding photography effects based on various information, such as a focusing distance (acquired from a position of a voice coil motor), RGB histograms, a depth histogram, sensor information, system information and/or an image disparity. As a result, a user can generally capture photos without manually applying the effects, and appropriate photography effects/configurations will be detected automatically and applied for the post usage after the image data are captured.

Another embodiment of the disclosure provides a non-transitory computer readable storage medium with a computer program to execute an automatic effect method disclosed in aforesaid embodiments. The automatic effect method includes steps of: when image data are captured, gathering information related to the image data, the information comprising a focusing distance of the camera set related to the image data; and, determining and recommending at least one suitable photography effect from a plurality of candidate photography effects according to the information related to the image data. Details of the automatic effect method are described in aforesaid embodiments as shown in FIG. 2 and FIG. 3, and not to be repeated here,

In this document, the term “coupled” may also be termed as “electrically coupled”, and the term “connected” may be termed as “electrically connected”. “Coupled” and “connected” may also be used to indicate that two or more elements cooperate or interact with each other. It will be understood that, although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. An electronic apparatus, comprising:
a camera set, configured for capturing image data; and
a non-transitory computer-readable medium having computer-executable instructions to be executed by the one or more processors for performing a method, comprising:
gathering information related to the image data, wherein the information related to the image data comprises a distance between a target object of a scene and the camera set; and
determining at least one suitable photography effect from a plurality of candidate photography effects according to the distance between the target object of the scene and the camera set.

2. The electronic apparatus of claim 1, wherein the information related to the image data comprises image characteristic information of the image data, wherein the method further comprises:
determining whether the captured image data is valid to apply any of the candidate photography effects or not according to the image characteristic information.

3. The electronic apparatus of claim 2, wherein the image characteristic information of the image data comprises exchangeable image file format (EXIF) data extracted from the image data, the exchangeable image file format (EXIF) data comprises dual image information corresponding to a pair of photos of the image data, time stamps corresponding to the pair of photos and focusing distances of the pair of photos, and the step of determining whether the captured image data is valid comprises:
checking the dual image information, the time stamps or the focusing distances so as to determine whether the captured image data is valid.

4. The electronic apparatus of claim 1, wherein the camera set comprises at least one voice coil motor, and the distance between the target object of the scene and the camera set is acquired by the voice coil motor.

5. The electronic apparatus of claim 1, wherein the camera set comprises dual camera units or a plurality of camera units.

6. The electronic apparatus of claim 1, wherein the candidate photography effects comprises at least one effect selected from the group including bokeh effect, refocus effect, macro effect, pseudo-3D effect, 3D-alike effect, 3D effect and a flyview animation effect.

7. The electronic apparatus of claim 6, wherein, if the distance between the target object of the scene and the camera set is shorter than a predefined reference, the suitable photography effect is substantially selected from the group consisting of macro effect, pseudo-3D effect, 3D-alike effect, 3D effect and a flyview animation effect.

8. The electronic apparatus of claim 6, wherein, if the distance between the largest object of the scene and the camera set is longer than a predefined reference, the suitable photography effect is substantially selected from the group consisting of bokeh effect and refocus effect.

9. The electronic apparatus of claim 1, wherein the method further comprising:
analyzing a depth distribution of the image data relative to the scene;
wherein the information related to the image data further comprises the depth distribution and the step of determining the at least one suitable photography effect comprises:
determining the suitable photography effect or a parameter of the suitable photography effect further according to the depth distribution.

10. The electronic apparatus of claim 1, further comprising:
a display panel, configured for displaying the image data and a selectable user interface, the selectable user interface is configured for recommending a user to select from the at least one suitable photography effect related to the image data;
wherein, after one of the suitable photography effects is selected on the user interface, the selected one of the suitable photography effects is applied to the image data.

11. A method, suitable for an electronic apparatus with a camera set, the method comprising;
capturing image data by the camera set;
gathering information related to the image data, the information comprising a distance between a target object of a scene and the camera set; and
determining at least one suitable photography effect from a plurality of candidate photography effects according to the distance between the target object of the scene and the camera set.

12. The method of claim 11, further comprising:
providing a selectable user interface, the selectable user interface being configured for recommending a user to select from the at least one suitable photography effect related to the image data.

13. The method of claim 12, further comprising:
before one from the at least one suitable photography effect is selected by the user, automatically applying one of suitable photography effects as a default photography effect to the image data shown in a digital album of the electronic apparatus.

14. The method of claim 12, further comprising;
after one from the at least one suitable photography effect is selected by the user, automatically applying the selected photography effect to the image data shown in a digital album of the electronic apparatus.

15. The method of claim 11, wherein the candidate photography effects comprises at least one effect selected from the group Including bokeh effect, refocus effect, macro effect, pseudo-3D effect, 3D-alike effect, 3D effect and a flyview animation effect.

16. The method of claim 15, wherein, if the the distance between the target object of the scene and the camera set is shorter than a predefined reference, the suitable photography effect is substantially selected from the group consisting of macro effect, pseudo-3D effect, 3D-alike effect, 3D effect and a flyview animation effect.

17. The method of claim 15, wherein, if the distance between the target object of the scene and the camera set is longer than a predefined reference, the suitable photography effect is substantially selected from the group consisting of bokeh effect and refocus effect.

18. The method of claim 11, further comprising:
analyzing a depth distribution of the image data, wherein the information related to the image data further comprises the depth distribution, and the suitable photography effect is determined further according to the depth distribution.

19. The method of claim 11, wherein the camera set comprises dual camera units or a plurality of camera units

20. The method of claim 11, wherein the information related to the image data comprises image characteristic information of the image data, the method further comprises:
determine whether the captured image data is valid to apply any of the candidate photography effects or not according to the image characteristic information.

21. The method of claim 11, wherein the image characteristic information of the image data comprises exchangeable image tile format (EXIF) data extracted from the image data, the exchangeable image file format (EXIF) data comprises dual image information corresponding to a pair of photos of the image data, time stamps corresponding to the pair of photos and focusing distances of the pair of photos, and the method further comprises:
checking the dual image information, the time stamps or the focusing distances so as to determine whether the captured image data is valid.

22. The method of claim 11, wherein the camera set comprises at least one voice coil motor, and the distance between the target object of the scene and the camera set is acquired by the voice coil motor.

23-30. (canceled)

31. A method, suitable for an electronic apparatus with a camera set, the method comprising:
capturing image data by the camera set;
gathering information related to the image data, the information comprising a distance between a target object of a scene and the camera set;
analyzing a depth distribution of the image data, wherein the information related to the image data further comprises the depth distribution; and
determining at least one suitable photography effect from a plurality of candidate photography effects according to the distance between the target object of the scene and the camera set and the depth distribution, wherein the at least one suitable photography effect is determined by comparing the distance between the target object of the scene and the camera set with a predefined reference and by comparing the depth distribution with a plurality of predetermined depth distributions.

32. The method of claim 31, further comprising:
providing a selectable user interface, the selectable user interface being configured for recommending a user to select from the at least one suitable photography effect related to the image data.

33. The method of claim 32, further comprising;
before one from the at least one suitable photography effect is selected by the user, automatically applying one of suitable photography effects as a default photography effect to the image data shown in a digital album of the electronic apparatus.

34. The method of claim 32, further comprising:
after one from the at least one suitable photography effect is selected by the user, automatically applying the selected photography effect to the image data shown in a digital album of the electronic apparatus.

35. The method of claim 31, wherein the candidate photography effects comprises at least one effect selected from the group including bokeh effect, refocus effect, macro effect, pseudo-3D effect, 3D-alike effect, 3D effect and a flyview animation effect.

36. The method of claim 35, wherein, if the distance between the target object of the scene and the camera set is shorter than the predefined reference, the suitable photography effect is substantially selected from the group consisting of macro effect, pseudo-3D effect, 3D-alike effect, 3D effect and a flyview animation effect,

37. The method of claim 35, wherein, if the distance between the target object of the scene and the camera set is longer than the predefined reference, the suitable photography effect is substantially selected from the group consisting of bokeh effect and refocus effect.

38. The method of claim 31, wherein the camera set comprises dual camera units or a plurality of camera units.
